(19) United States
(12) Patent Application Publication
(10) Pub. No.: US 2017/0124523 A1
(43) Pub. Date: May 4, 2017

(54) SYSTEM AND METHOD FOR PROVIDING SERVICE FOR APPOINTMENT AT DOCTOR'S BASED ON HEALTH STATUS

(71) Applicant: SK PLANET CO., LTD., Gyeonggi-do (KR)

(72) Inventor: Youngmin YOON, Seoul (KR)

(73) Assignee: SK PLANET CO., LTD., Gyeonggi-do (KR)

(21) Appl. No.: 15/217,467

(22) Filed: Jul. 22, 2016

(30) Foreign Application Priority Data
Oct. 28, 2015 (KR) 10-2015-0150323

(51) Int. Cl. G06Q 10/10; G06F 19/00; G06Q 50/22

(52) U.S. Cl. CPC G06Q 10/1095; G06Q 50/22; G06F 19/327

(57) ABSTRACT

Disclosed herein are a system and method for providing a service for an appointment at the doctor's based on a health status. There is provided an apparatus for providing a service for an appointment at a doctor's, including a communication unit configured to perform communication with a hospital management apparatus, a sensor unit configured to measure biological information about a user, and a control unit configured to send the biological information measured by the sensor unit to the hospital management apparatus through the communication unit, receive appointment information when a clinic visit request message is received from the hospital management apparatus, and send the appointment information to the hospital management apparatus.

### CROSS REFERENCE TO RELATED APPLICATION

The present application claims the benefit of Korean Patent Application No. 10-2015-0150323 filed in the Korean Intellectual Property Office on Oct. 28, 2015, the entire contents of which are incorporated herein by reference.

### BACKGROUND OF THE INVENTION

1. Technical Field

The present invention relates to a system and method for providing a service for an appointment at the doctor's based on a health status and, more particularly, to a system and method for providing a service for an appointment at the doctor's based on a health status, wherein whether a user needs to receive a doctor's medical examination and treatment is determined using biological information measured through a user device, a clinic visit request message is provided if, as a result of the determination, the medical treatment is required so that the user can input appointment information.

2. Description of the Related Art

A wearable device means a device capable of being worn on the human body literally. The wearable device includes various types, such as glasses, a watch, a bracelet, shoes, a ring, a belt, a band, a necklace, a headset, and clothes, depending on a portion on which the wearable device is worn. Such a wearable device is rapidly spread. Wearable glasses, a wearable watch and wearable band which are very closely related to human life and can be easily worn form the most product group.

The wearable device is also called a smart device. The reason for this is that the driving of the wearable device needs to be started up by a user input, but once the wearable device is driven, it can automatically generate various types of additional information and provide them to a user. For example, if a user who has worn a wearable watch wants to measure his or her heart rate, he or she presses a heart rate measurement input button. At the same time, the wearable watch may measure the user's heart rate, may generate various types of information based on the measured heart rate, and may provide them to the user. Recently, many wearable devices that do not require the startup of driving by a user input are appearing. For example, a wearable band may continue to measure a user's heart rate although there is no startup of driving by a user input. There is a good possibility that the future wearable device not requiring the startup of driving by a user input will be developed. The reason for this is that convenience in device driving is increased because a user input is not required.

The root of various types of additional information provided from such a wearable device to a user is pieces of information measured from the user. Accordingly, sensors for measuring various types of information about a user need to be mounted on a wearable device. As the type of sensors mounted on a wearable device is increased, many pieces of information about a user may be measured. For this reason, a heart rate measurement sensor, a global positioning system (GPS) sensor, and a step number measurement sensor tend to be essentially mounted on a recent wearable device. Research for mounting various sensors on a limited device continues to be carried out.

The wearable device may measure information about a user through a mounted sensor, may generate various types of additional information based on the measurement information, and may provide them to the user. For example, the wearable device may measure the current location of a user and provide the user with information about nearby stores or products related to the user's interest. Such additional information may be provided through the function of the wearable device itself. Recently, an application that is installed on a wearable device is also developed because a single wearable device is unable to provide all of pieces of additional information for different users. In this case, the application may be considered to be a kind of application program. The application may function to generate various types of additional information based on information measured through the function of the wearable device itself and provide them. In the above example, the information about nearby stores or products related to the user's interest may be performed by an application. That is, whenever a new application is developed, additional information which may be provided to a user through a wearable device become various. The development of an application may be considered to be a forward partner along with the development of a wearable device itself.

Recently, one of the major interests of a related industry is to construct a system capable of payment through a wearable device. For example, if a near field communication (NFC) function is included in a wearable device itself and a user's credit card is registered with an application, the user can perform payment through the wearable device even without take his or her purse out of his or her pocket. That is, a conventional wallet may be substituted with a mobile wallet function.

A system for checking the health status of a user using a wearable device and providing a service that provides notification of the health status has been constructed. However, a conventional system provides only the health status of a user, but does not provide a technology for providing a service suitable for a health status.

### PRIOR ART DOCUMENT

### Patent Document

(Patent Document 1) Prior Art 1: Korean Patent No. 1218593 titled “Medical Information Service System and Method Thereof”

### SUMMARY OF THE INVENTION

An object of the present invention is to provide a system and method for providing a service for an appointment at the doctor's based on a health status, wherein a user's health status is checked using information measured by a wearable device and a user's appointment with a doctor is made if, as a result of the check, medical treatment is required.

Another object of the present invention is to provide a system and method for providing a service for an appointment at the doctor's based on a health status, wherein when a user finishes a clinic visit and medical examination at the appointed time, customized health management information for enhancing the user's health can be provided to a wearable device or user device worn on the user.

Yet another object of the present invention is to provide a system and method for providing a service for an appointment at the doctor's based on a health status, wherein an emergency situation in a user's health can be immediately handled using biological information measured by a wearable device.

Technical objects to be achieved by the present invention are not limited to the objects, and they may include various technical objects within a range evident to those skilled in the art from the following description.

In accordance with an aspect of the present invention, there is provided an apparatus for providing a service for an appointment at a doctor's, including a communication unit configured to perform communication with a hospital management apparatus, a sensor unit configured to measure biological information about a user, and a control unit configured to send the biological information measured by the sensor unit to the hospital management apparatus through the communication unit, receive appointment information when a clinic visit request message is received from the hospital management apparatus, and send the appointment information to the hospital management apparatus.

The control unit may compare the measured biological information of the sensor unit with previously stored biological reference information, may send measurement information including the biological information to the hospital management apparatus through the communication unit if, as a result of the comparison, a health status is found to be abnormal, and may notify predetermined emergency contact information of an emergency situation if, as a result of the comparison, the health status is found to be a dangerous condition.

Furthermore, the control unit may receive customized health management information based on the contents of medical treatment from the hospital management apparatus.

The apparatus for providing a service for an appointment at the doctor's may include a wearable device. The sensor unit may measure the biological information of the user in real time.

In accordance with another aspect of the present invention, there is provided a hospital management apparatus, including a communication unit configured to perform communication with a user device, a health status check unit configured to determine whether a user requires medical treatment based on biological information when the biological information is received from the user device through the communication unit, generate a clinic visit request message if, as a result of the determination, it is determined that the user requires medical treatment, and send the clinic visit request message to the user device, an appointment processing unit configured to store appointment information when the appointment information is received from the user device and to send an appointment notification message to the user device prior to an appointment date, and a medical treatment completion processing unit configured to generate customized health management information based on the contents of the medical treatment when medical treatment completion information is received and to send the customized health management information to the user device.

The health status check unit may compare the biological information with previously stored biological reference information, and may determine whether the user requires the medical treatment based on a result of the comparison or may send the biological information to a medical staff and may receive information about whether the user requires the medical treatment.

In accordance with yet another aspect of the present invention, there is provided a method for providing, by a user device, a service for an appointment at the doctor's based on a health status, including the steps of (a) measuring biological information about a user, (b) determining a health status of the user by comparing the measured biological information with previously stored biological reference information, and (c) sending the biological information to a hospital management apparatus if, as a result of the determination, it is determined that the health status of the user is abnormal, receiving appointment information when a clinic visit request message is received from the hospital management apparatus, and sending the appointment information to the hospital management apparatus.

The method may further include the step of receiving customized health management information based on the contents of medical treatment from the hospital management apparatus after the step (c).

If the health status of the user is an emergency situation at the step (c), predetermined emergency contact information may be notified of emergency situation information.

The “system and method for providing a service for an appointment at the doctor's based on a health status” may be implemented in a program form and recorded on a medium readable by an electronic device or may be distributed through a program download management apparatus (e.g., a server).

### BRIEF DESCRIPTION OF THE DRAWINGS

FIG. 1 is a diagram showing a system for providing a service for an appointment at the doctor's based on a health status according to an embodiment of the present invention.

FIG. 2 is a block diagram schematically showing the configuration of a wearable device according to an embodiment of the present invention.

FIG. 3 is a block diagram schematically showing the configuration of a hospital management apparatus according to an embodiment of the present invention.

FIG. 4 is a diagram showing a method for providing a service for an appointment at the doctor's based on a health status according to an embodiment of the present invention.

FIG. 5 is a diagram showing a method for performing, by the wearable device, an appointment at the doctor's based on a health status according to an embodiment of the present invention.

FIG. 6 is a diagram showing a method for performing, by the hospital management apparatus, an appointment at the doctor's based on a health status according to an embodiment of the present invention.

### DETAILED DESCRIPTION

Hereinafter, a system and method for providing a service for an appointment at the doctor's based on a health status according to embodiments of the present invention are described in detail with reference to the accompanying drawings. The embodiments to be described are provided in order for those skilled in the art to easily understand the technical spirit of the present invention, and the present invention is not restricted by the embodiments. Furthermore, contents represented in the accompanying drawings have been diagrammed in order to easily describe the embodiments of the present invention, and the contents may be different from forms that are actually implemented.

Each of elements to be described herein is only an example for implementing an embodiment of the present invention. Accordingly, in other implementations of the present invention, a different element may be used without departing from the spirit and scope of the present invention.

Furthermore, each of the elements may be purely implemented using a hardware or software element, but may be implemented using a combination of various hardware and software elements that perform the same function.

Furthermore, an expression that some elements are “included” is an expression of an “open type”, and the expression simply denotes that the corresponding elements are present, but should not be construed as excluding additional elements.

FIG. 1 is a diagram showing a system for providing a service for an appointment at the doctor's based on a health status according to an embodiment of the present invention.

Referring to FIG. 1, the system for providing a service for an appointment at the doctor's based on a health status includes an apparatus 100 for providing a service for an appointment at the doctor's and a hospital management apparatus 200. The apparatus 100 and the hospital management apparatus 200 are interconnected over a communication network. The apparatus 100 for providing a service for an appointment at the doctor's is a user device and may be implemented using a wearable device, for example. In this case, the apparatus 100 may measure biological information in real time. Hereinafter, the apparatus 100 for providing a service for an appointment at the doctor's is illustrated as being a wearable device, but the apparatus 100 for providing a service for an appointment at the doctor's according to an embodiment of the present invention is not limited to the wearable device.

The wearable device 100 measures biological information about a user and sends measurement information, including the measured biological information, to the hospital management apparatus 200. When a clinic visit request message is received from the hospital management apparatus 200, the wearable device 100 receives appointment information from the user and sends the appointment information to the hospital management apparatus 200. In this case, the measurement information may include biological information, location information, and wearable device ID information. The biological information may include a pulse rate, a blood pressure level, blood sugar and so on. The clinic visit request message may include a doctor's medical treatment object, a hospital name, a hospital route map, a possible appointment time and so on. The appointment information may include a hospital name, a doctor, an appointment time and so on.

Furthermore, the wearable device 100 may compare measured biological information with previously stored biological reference information and determine whether the health status of the user is normal or not based on a result of the comparison. If, as result of the determination, it is determined that the health status is abnormal, the wearable device 100 may send measurement information, including the biological information, to the hospital management apparatus 200. When a clinic visit request message is received from the hospital management apparatus 200, the wearable device 100 may receive appointment information from a user and send the appointment information to the hospital management apparatus 200. In this case, if the health status of the user is an emergency situation, the wearable device 100 may notify predetermined emergency contact information of the emergency situation. The emergency contact information may include an emergency phone number (e.g., 119 in Korea), an emergency center, and an acquaintance. The emergency situation may be notified through a call or a message.

Furthermore, after medical treatment is completed, the wearable device 100 receives customized health management information based on a disease or the contents of medical treatment from the hospital management apparatus 200. The customized health management information is information for making better the health status of a user, and may include information for consistent health management by providing a health food discount coupon, a sports equipment discount coupon, hospital medical treatment points, or a sports center discount coupon, for example.

Such a wearable device 100 means a device which may be worn on the human body, and may include various types, such as glasses, a watch, a bracelet, shoes, a ring, a belt, a band, a necklace, a headset, and clothes, depending on a portion on which the wearable device is worn.

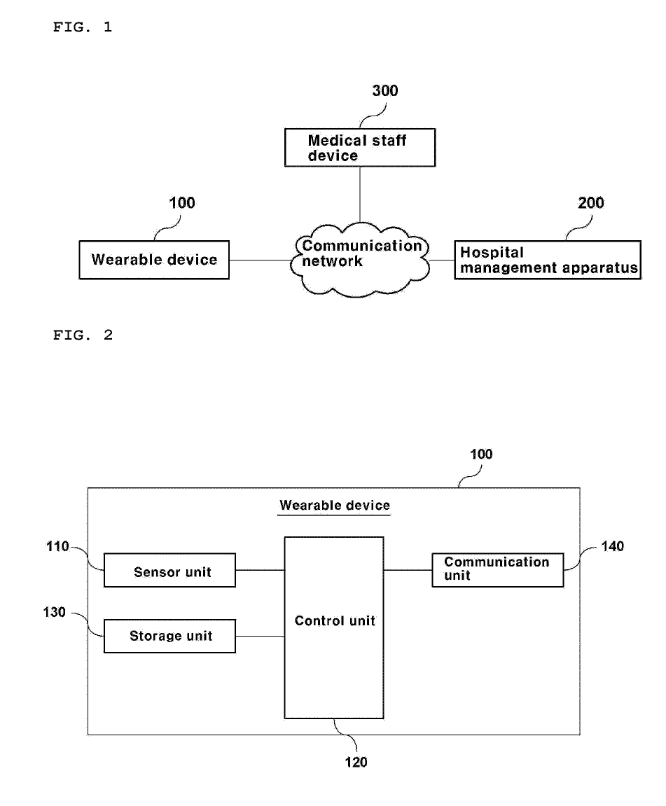

The wearable device 100 is described in detail later with reference to FIG. 2.

When measurement information including biological information is received from the wearable device 100, the hospital management apparatus 200 compares the biological information with previously stored biological reference information, and determines whether the health status of a user is normal or not based on a result of the comparison. If, as a result of the determination, it is determined that the user requires medical treatment, the hospital management apparatus 200 generates a clinic visit request message and sends it to the wearable device 100. For example, if a heart rate included in heart beat information is out of any one of the lowest threshold and the highest threshold included in heart beat reference information, the hospital management apparatus 200 determines the heart health status of a user to be abnormal, determines that the user requires medical treatment, and sends a clinic visit request message to the wearable device 100 of the user. In this case, the hospital management apparatus 200 selects a hospital in which medical treatment suitable for the health status of the user will be performed, obtains a possible appointment time for the medical staffs of a corresponding medical treatment part at the selected hospital, generates a clinic visit request message including the obtained hospital name, hospital route map, medical staffs, and possible appointment time, and sends the generated clinic visit request message to the wearable device 100 of the user. Furthermore, if a hospital or a doctor in charge (or the physician in charge) set in the user is present, the hospital management apparatus 200 may check the set hospital and a possible appointment time of the doctor in charge, may generate a clinic visit request message including a hospital name, hospital route map, medical staff, and possible appointment time, and may send the generated clinic visit request message to the wearable device 100 of the user.

Furthermore, if the health status of a user is determined to be an emergency situation as a result of a comparison between biological information and previously stored biological reference information, the hospital management apparatus 200 provides notification of emergency situation information through an emergency center or an emergency phone number. The emergency situation information may include health status information and location information about a user. The health status information may include biological information.

When appointment information is received from the wearable device 100, the hospital management apparatus 200 stores the appointment information and sends an appointment notification message to the wearable device 100 of a user prior to an appointment date. The appointment information may include a hospital name, a doctor, an appointment time and so on.

When medical treatment completion information is received, the hospital management apparatus 200 generates customized health management information based on a disease or the contents of medical treatment and sends it to the wearable device 100 of the user. That is, the hospital management apparatus 100 generates customized health management information, including a coupon or loyalty points at a food store, a health food coupon, a sports equipment coupon, or hospital medical treatment points suitable for the user, based on the health status or disease of the user, and sends the generated customized health management information to the wearable device 100 in a push form. For example, if blood pressure of a user is high, the hospital management apparatus 100 may provide customized health management information, such as a discount coupon or loyalty points for health food which is good for blood pressure.

The hospital management apparatus 200 may be implemented using a single operation device or may be implemented in the form of an aggregate device in which two or more operation devices have been connected. For example, the hospital management apparatus 200 may be implemented using a single server or may be implemented in a form in which two or more servers have been connected.

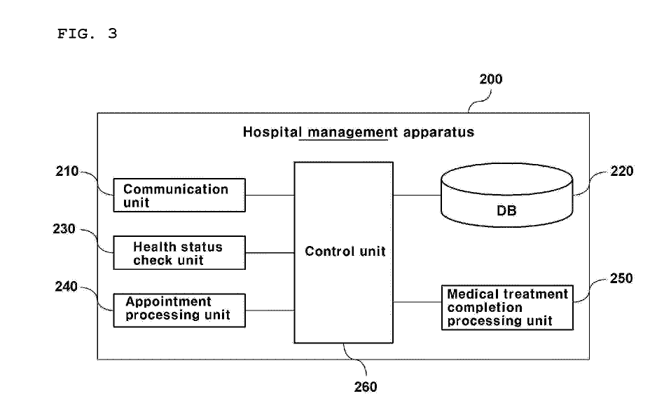

The hospital management apparatus 200 is described in detail with reference to FIG. 3.

In accordance with another embodiment of the present invention, the system for providing a service for an appointment at the doctor's based on a health status may further include a medical staff device 300. The medical staff device 300 may be the terminal of a professional (e.g., a doctor) who provides professional medical treatment and a counseling service to a user using health status information provided by the hospital management apparatus 200.

In this case, when measurement information including biological information is received from the wearable device 100, the hospital management apparatus 200 determines a medical staff designated by a user, such as a doctor in charge or the physician in charge, and requests the determined medical staff device 300 to check the health status of the user by transferring the biological information to the determined medical staff device 300. In response to the request, the medical staff accesses the hospital management apparatus 200 using the medical staff device 300, checks the health status of the user, and inputs health status check information. In this case, the health status check information may include information about whether medical treatment is required or not. If a need for medical treatment is indicated in the health status check information, the hospital management apparatus 200 generates a clinic visit request message, including a doctor's medical treatment object, a hospital name, a hospital route map, and a possible appointment time, and sends the generated clinic visit request message the wearable device 100 of the user.

The medical staff may receive biological information about a user from the hospital management apparatus 200 using the medical staff device 300, may pronounce a diagnosis of the health status of the user, and may consult with the user. The medical staff may be a professional medical staff, such as a doctor or a nurse, but may be a related expert, such as a care worker, a health care worker, a physical training worker, or a physical therapist. The medical staff device 300 may be a communication terminal, such as a computer, a laptop computer, a netbook, or a PDA, or may be a smart device, such as a smart phone, a smart note, a tablet PC, or smart TV. The medical staff may consult with the user through the medical staff device 300 on-line or may consult with the user through a telephone or perform remote medical treatment using a separate expert health care system, if necessary.

In the above example, the wearable device 100 is equipped with a display unit, and may display the clinic visit request message, the appointment notification message, the customized health management information, and the measured biological information received from the hospital management apparatus 200. In some embodiments, the wearable device 100 may not be equipped with a display unit. In this case, the system for providing a service for an appointment at the doctor's based on a health status may further include a user device (not shown). The user device may be a user terminal, for example.

In another embodiment of the present invention, the system for providing a service for an appointment at the doctor's based on a health status may further include a user device for storing and outputting biological information measured by the wearable device 100 or a clinic visit request message, an appointment notification message, and customized health management information received from the hospital management apparatus 200.

Accordingly, in an embodiment of the present invention, the user device in addition to the wearable device 100 and the hospital management apparatus 200 also cooperatively operates. Accordingly, although a user does not wear the wearable device 100, biological information can be provided to the user, and a clinic visit request message, an appointment notification message, and customized health management information received from the hospital management apparatus 200 can be provided to the user.

The wearable device 100 may periodically measure and predict health information about a user by transmitting and receiving data to and from the user device.

The wearable device 100 may send the measured biological information to a user device (e.g., a smart phone) paired with the wearable device 100. For example, the wearable device 100 may send and receive data using a short-distance communication network, such as NFC or Bluetooth. In this case, the measured biological information may be transmitted from the user device to the hospital management apparatus 200 over a communication network. The wearable device 100 may receive a clinic visit request message, an appointment notification message, and customized health management information, generated by the hospital management apparatus 200, from the hospital management apparatus 200, and may transmit the received clinic visit request message, appointment notification message, or customized health management information from the wearable device 100 to the user device.

The user device includes a personal digital assistant (PDA), a smart phone, a cellular phone, a personal communication service (PCS) phone, a global system for mobile (GSM) phone, a wideband CDMA (W-CDMA) phone, a CDMA-2000 phone, and a mobile broadband system (MBS) phone which may be applied to various wired and/or wireless environments. In this case, the user device may be a portable small-sized device, but may denote a mobile communication terminal if it includes a camcorder or a laptop computer. In an embodiment of the present invention, the user device is not specially limited to the examples.

FIG. 2 is a block diagram schematically showing the configuration of the wearable device according to an embodiment of the present invention.

Referring to FIG. 2, the wearable device 100 includes a sensor unit 110, a control unit 120, a storage unit 130, and a communication unit 140.

The sensor unit 110 is mounted on the wearable device 100 and measures biological information about a user. In this case, the biological information may include the pulse, blood pressure, blood sugar, and peripheral capillary oxygen saturation (SpO2). In this case, the sensor unit 110 senses the basic physical quantities, such as a current, a voltage, and resistance including biological measurement information, and converts the sensed basic physical quantities into data of a required form. The sensor unit 110 includes a corresponding measurement sensor depending on the type of object to be measured, and may include a pulse sensor, a blood pressure sensor, and a blood sugar sensor, for example. The sensor unit 110 senses measured biological information periodically or persistently and sends a corresponding electrical signal to the control unit 120. Accordingly, a user can check the results through the wearable device 100 or a user device operating in conjunction with the wearable device 100. In a dangerous situation, the wearable device 100 or a user device operating in conjunction with the wearable device 100 may directly notify the outside of the results instead of a user.

Furthermore, the sensor unit 110 measures location information in addition to biological information about a user. In this case, the sensor unit 110 may include a biological information sensor and a position sensor. The biological information sensor measures biological information about a user, and may include a pulse sensor and a blood pressure sensor, for example. The position sensor measures the current location of a user and may include a GPS sensor, for example.

The control unit 120 sends measurement information, including biological information and location information measured by the sensor unit 110, to the hospital management apparatus through the communication unit 140. In this case, the measurement information may include the biological information, the location information, wearable device ID information and so on.

Furthermore, the control unit 120 may compare biological information, measured by the sensor unit 110, with previously stored biological reference information and determine whether the health status of a user is normal or not based on a result of the comparison. If, as a result of the determination, it is determined that the health status is abnormal, the control unit 120 may send measurement information, including the biological information, to the hospital management apparatus. For example, if a heart rate is out of any one of the lowest threshold and the highest threshold included in heart beat reference information, the control unit 120 may determine the heart health status of a user to be abnormal and send measurement information to the hospital management apparatus. Furthermore, if the change pattern of a heart rate is out of a change pattern permission range included in heart beat reference information, the control unit 120 may determine the heart health status of a user to be abnormal. If the health status of a user is abnormal, the control unit 120 sends measurement information, including biological information and location information, to the hospital management apparatus. In this case, if the health status of the user is an emergency situation, the control unit 120 may notify predetermined emergency contact information of the emergency situation. The control unit 120 may determine whether the health status of a user is an emergency situation or not because an emergency situation stage and an abnormal stage have been set based on the importance of biological information and the degree that biological reference information has been deviated. The emergency contact information may include an emergency phone number, an emergency center, and an acquaintance and may provide notification of an emergency situation through a call or a message.

When a clinic visit request message is received from the hospital management apparatus through the communication unit 140, the control unit 120 receives appointment information from a user and sends the appointment information to the hospital management apparatus. In this case, the clinic visit request message may include a doctor's medical treatment object, a hospital name, a hospital route map, a possible appointment time and so on. The appointment information may include a hospital name, a doctor, and an appointment time. The appointment information may be received through an input unit (not shown) if the wearable device 100 is equipped with the input unit, and may be received through a user device paired with the wearable device 100 if the wearable device 100 is not equipped with the input unit.

Furthermore, after medical treatment for a user is completed, the control unit 120 receives customized health management information based on a disease or the contents of medical treatment from the hospital management apparatus. The customized health management information may include a health food discount coupon, a sports equipment discount coupon, hospital medical treatment points, and a sports center discount coupon.

The control unit 120 may include at least one operation device. In this case, the operation device may be a general-purpose central processing unit (CPU), a programmable device (CPLD, FPGA) suitably implemented for a specific purpose, an application-specific integrated circuit (ASIC) or a microcontroller chip.

The storage unit 130 is an element for storing data related to the operation of the wearable device 100. A known storage medium may be used as the storage unit 130. The storage unit 130 may include one or more of known storage media, such as ROM, PROM, EPROM, EEPROM, and RAM. More specifically, biological reference information, that is, a criterion by which the control unit 120 determines whether the health status of a user is normal, has been stored in the storage unit 130. The biological reference information is a criterion for determining a user's health status and may be configured in various ways. For example, heart beat reference information may include the lowest threshold and the highest threshold obtained by adding and subtracting a specific number to and from a heart rate when a user is a normal state. If the heart rate of a user is less than the lowest threshold or exceeds the highest threshold, the user may be determined to be in a dangerous situation, that is, a heart health status is abnormal. For another example, heart beat reference information may include a change pattern unique to the heart rate of a user and a permission variation range of the unique change pattern. In this case, if the change pattern of the heart rate of the user is out of the permission variation range, the user may be determined to be in a dangerous situation [symbol] , that is, a heart health status is abnormal.

The storage unit 130 may store an application (or applet) capable of performing a service for an appointment at the doctor's based on a health status. Pieces of the stored information may be optionally selected by the control unit 120, if necessary.

The control unit 120 may store an application (or applet) capable of performing service processing for an appointment at the doctor's based on a health status in the storage unit 130. The control unit 120 may drive and control such an application so that a clinic visit request message, customized health management information, etc. provided by the hospital management apparatus are output.

The communication unit 140 sends and receives data to and from various electronic devices. More specifically, the communication unit 140 may be connected to two or more devices, and may send and receive various types of information, such as measurement information, a clinic visit request message, customized health management information, and appointment information.

The wearable device 100 according to an embodiment of the present invention may further include a display unit (not shown) for displaying various types of information related to the operation of the wearable device 100. More specifically, the display unit may display various types of information, such as biological information measured by the sensor unit 110, a clinic visit request message and customized health management information received from the hospital management apparatus, and appointment information inputted by a user. The display unit may be implemented through various display devices, such as an LCD and an LED.

The wearable device 100 according to an embodiment of the present invention may further include an input unit (not shown) for receiving information from a user. More specifically, the input unit may be used to receive information, such as appointment information. The input unit may be implemented using an input device, such as a keypad or a touch panel. In addition to such an input device, the input unit may be implemented using various input devices. Furthermore, the input unit may also be implemented in the form of a touch screen integrated with a display unit.

The wearable device 100 according to an embodiment of the present invention may further include a power supply unit (not shown) for supplying power. Furthermore, the wearable device 100 according to an embodiment of the present invention may further include a short-distance communication unit (not shown) for short-distance wireless communication with a user device owned by a user. The short-distance communication unit may operate in accordance with various standards, such as Wi-Fi, Bluetooth communication, Zigbee communication, infrared communication (IrDA), a radio frequency (RF), such as an ultra high frequency (UHF) and a very high frequency (VHF), and ultra-wide band communication (UWB).

FIG. 3 is a block diagram schematically showing the configuration of the hospital management apparatus according to an embodiment of the present invention.

Referring to FIG. 3, the hospital management apparatus 200 includes a communication unit 210, a database (DB) 220, a health status check unit 230, an appointment processing unit 240, a medical treatment completion processing unit 250, and a control unit 260.

The communication unit 210 may receive measurement information, including biological information, from the wearable device over a communication network, and may send and receive a clinic visit request message or customized health management information to and from the wearable device. In this case, the communication network includes all types of wired and wirelesses communication. The wearable device and the hospital management apparatus 200 are interconnected over the communication network.

The database 220 includes a hospital database in which hospital-related information has been stored and a user database in which user-related information has been stored.

A hospital name, a hospital location, medical staff information, appointment information, etc. have been stored in the hospital database.

User information (e.g., a name, user ID information, and wearable device ID information, biological information, a health status, location information, etc. have been stored in the user database. Furthermore, appointment information requested by a user, customized health management information, etc. have been stored in the user database.

The database 220 is an apparatus for storing data, and basically stores data, such as environment variables for search, classification, and an analysis. The functions of the database 220 may be implemented using a known technology, and a detailed description of the database is omitted.

When measurement information including biological information is received from the wearable device through the communication unit 210, the health status check unit 230 compares the biological information with previously stored biological reference information and determines whether the health status of a user is normal or not based on a result of the comparison. If, as a result of the determination, it is determined that the user requires medical treatment, the health status check unit 230 generates a clinic visit request message and sends it to the wearable device of the user. For example, if a heart rate included in heart beat information is out of any one of the lowest threshold and the highest threshold included in heart beat reference information, the health status check unit 230 determines the heart health status of a user to be abnormal, determines that the user requires medical treatment, and sends a clinic visit request message to the wearable device of the user. In this case, the health status check unit 230 selects a hospital in which the medical treatment suitable for the health status of the user will be performed by searching a hospital database, obtains a possible appointment time of the medical staffs of a corresponding medical treatment part in the selected hospital, and sends a clinic visit request message, including the obtained hospital name, hospital route map, medical staffs, and possible appointment time, to the wearable device of the user. Furthermore, if a hospital and/or a doctor in charge (or the physician in charge) set in the user are present as a result of the search of the user database, the health status check unit 230 may check a possible appointment time of the set hospital and/or doctor in charge and may send a clinic visit request message, including the hospital name, hospital route map, medical staff, and possible appointment time, to the wearable device of the user. Furthermore, if the hospital management apparatus 200 manages a plurality of hospitals, the health status check unit 230 may select a hospital at which a doctor in charge or the physician in charge of a user works or a hospital having the use history of a user based on the hospital use history of the user, may generate a clinic visit request message including the name of the selected hospital, a medical treatment object, a hospital route map, and a possible appointment time, and may send the generated clinic visit request message to the wearable device.

Furthermore, if the health status of a user is determined to be an emergency situation as a result of a comparison between biological information and previously stored biological reference information, the health status check unit 230 notifies an emergency center or an emergency phone number of emergency situation information. The emergency situation information may include information about the location of the user. The health status check unit 230 may determine whether the health status of a user is an emergency situation or not because an emergency situation stage and an abnormal stage have been set based on the importance of biological information and the degree that biological reference information has been deviated.

In accordance with another embodiment of the present invention, when measurement information including biological information is received from the wearable device through the communication unit 210, the health status check unit 230 searches the user database, determines a medical staff, such as a doctor in charge or the physician in charge who has been designated by a user, and requests the determined medical staff to check the health status of the user by sending the biological information to the determined medical staff. The medical staff accesses the hospital management apparatus 200, checks the health status of the user, and inputs health status check information. In this case, the health status check information may include information about whether medical treatment is required or not. If a need for medical treatment is indicated in the health status check information, the health status check unit 230 generates a clinic visit request message including a doctor's medical treatment object, a hospital name, a hospital route map, and a possible appointment time, and sends the generated clinic visit request message to the wearable device of the user. The clinic visit request message may be a push message type.

When appointment information is received from a user, the appointment processing unit 240 stores the appointment information and sends an appointment notification message to the wearable device of the user prior to an appointment date. In this case, “prior to the appointment date” means two days or one day before the appointment date. The appointment information may include a hospital name, a doctor, an appointment time, etc.

When medical treatment completion information is received, the medical treatment completion processing unit 250 generates customized health management information based on a disease or the contents of medical treatment, and sends the customized health management information to the wearable device of the user. In this case, the customized health management information is information for enhancing a user's health, and may include a health food discount coupon, a sports equipment discount coupon, hospital medical treatment points, and a sports center discount coupon, for example.

That is, the medical treatment completion processing unit 250 generates customized health management information, including a coupon or loyalty points at a food store, a health food coupon, a sports equipment coupon, or hospital medical treatment points suitable for a user, based on the health status or disease if the user, and sends the generated customized health management information to the wearable device in a push form. For example, if blood pressure of a user is high, the medical treatment completion processing unit 250 may provide customized health management information, such as a discount coupon or loyalty points for health food which is good for blood pressure.

Each of the health status check unit 230, the appointment processing unit 240, and the medical treatment completion processing unit 250 may be implemented using a processor required to execute a program on a computing device. As described above, the health status check unit 230, the appointment processing unit 240, and the medical treatment completion processing unit 250 may be implemented using physically independent elements or may be implemented in such a manner that they are functionally divided within a single processor.

The control unit 260 controls the operations of various elements of the hospital management apparatus 200, including the communication unit 210, the database 220, the health status check unit 230, the appointment processing unit 240, and the medical treatment completion processing unit 250.

The control unit 260 may include at least one operation device. In this case, the operation device may be a general-purpose central processing unit (CPU), a programmable device (CPLD, FPGA) suitably implemented for a specific purpose, an application-specific integrated circuit (ASIC), or a microcontroller chip.

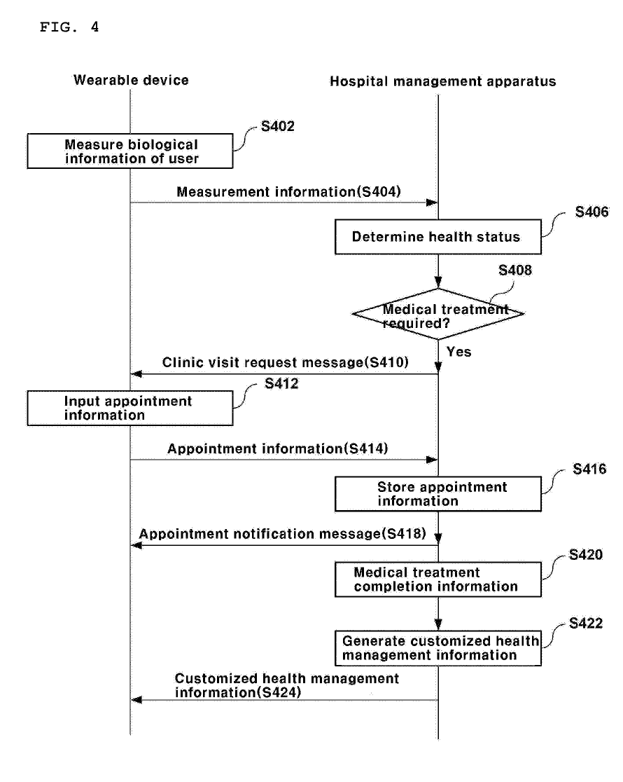

FIG. 4 is a diagram showing a method for providing a service for an appointment at the doctor's based on a health status according to an embodiment of the present invention.

Referring to FIG. 4, the wearable device measures biological information and location information about a user at step S402 and sends measurement information, including the measured biological information and location information, to the hospital management apparatus at step S404. In this case, the biological information may include a heart rate, the pulse, blood pressure, and a body temperature.

The hospital management apparatus compares the biological information included in the measurement information with previously stored biological reference information at step S406, and determines whether the user requires medical treatment or not based on a result of the comparison (S408). In this case, if the biological information included in the measurement information is out of predetermined biological reference information, the hospital management apparatus may determine the health status of the user to be abnormal and determine that the user requires medical treatment. For example, if a heart rate included in heart beat information is out of any one of the lowest threshold and the highest threshold included in heart beat reference information, the hospital management apparatus may determine the heart health status of the user to be abnormal. Furthermore, if the change pattern of a heart rate included in heart beat information is out of a change pattern permission range included in heart beat reference information, the hospital management apparatus may determine the heart health status of the user to be abnormal.

Furthermore, if the biological information included in the measurement information is out of predetermined biological reference information, the hospital management apparatus determines a hospital and a medical staff in which medical treatment suitable for the health status of the user will be performed, and requests the determined medical staff to check the health status of the user. For example, if blood pressure of the user is abnormal, the hospital management apparatus may determine a hospital and a medical staff which are good for blood pressure treatment and request the determined medical staff to check the health status of the user. Furthermore, if a hospital and medical staff designated by the user have been set, the hospital management apparatus may request the determined medical staff to check the health status of the user. In response to the request, the medical staff accesses the hospital management apparatus, checks the health status of the user, and inputs health status check information. In this case, the health status check information may include information about whether the user requires medical treatment or not.

If, as a result of the determination at step S408, it is determined that medical treatment is required, the hospital management apparatus generates a clinic visit request message and sends it to the wearable device at step S410. In this case, the hospital management apparatus may select a hospital in which medical treatment suitable for the health status of the user will be performed, may obtain a possible appointment time of the medical staffs of a corresponding medical treatment part in the selected hospital, may generate the clinic visit request message including the obtained hospital name, hospital route map, medical staff, and possible appointment time, and may send the generated clinic visit request message to the wearable device. Furthermore, if a hospital or a doctor in charge (or the physician in charge) designated by the user is present, the hospital management apparatus may check a possible appointment time of the designated hospital and doctor in charge, may generate the clinic visit request message including a hospital name, a hospital route map, a medical staff, and a possible appointment time, and may send the generated clinic visit request message to the wearable device. Furthermore, if the hospital management apparatus manages a plurality of hospitals, the hospital management apparatus may select a hospital in which a doctor in charge or the physician in charge of the user works or a hospital having a use history based on the hospital use history of the user, may generate the clinic visit request message including the name of the selected hospital, a medical treatment object, a hospital route map, and a possible appointment time, and may send the generated clinic visit request message to the wearable device.

In response to the clinic visit request message, the wearable device displays the clinic visit request message in a push form. When appointment information is received from the user at step S412, the wearable device sends the inputted appointment information to the hospital management apparatus at step S414. The appointment information may include a hospital name, a doctor, and an appointment time.

The hospital management apparatus stores the appointment information at step S416 and sends an appointment notification message to the wearable device prior to an appointment date at step S418.

Thereafter, when medical treatment completion information is received at step S420, the hospital management apparatus generates customized health management information based on the contents of the medical treatment at step S422 and sends the generated customized health management information to the wearable device at step S424.

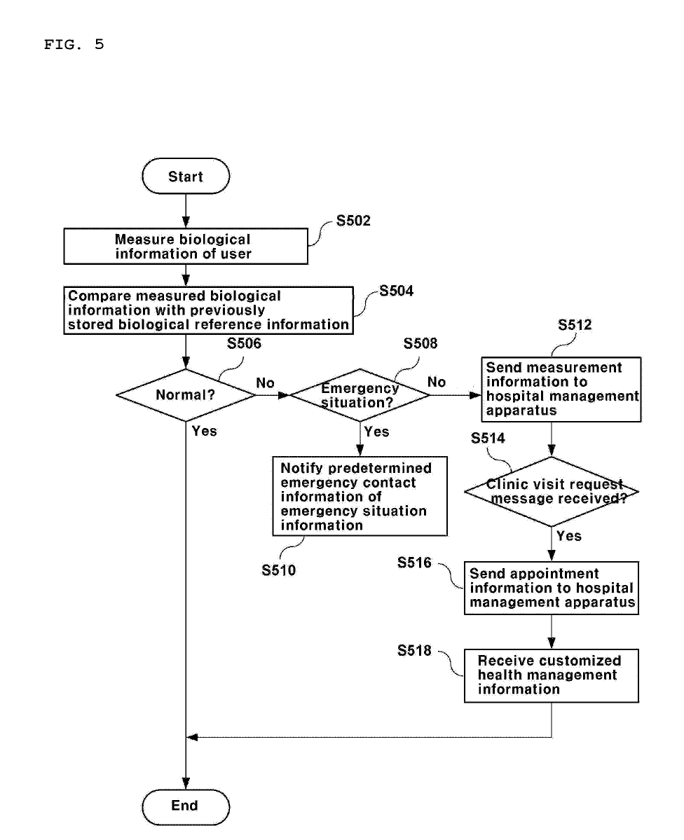

FIG. 5 is a diagram showing a method for performing, by the wearable device, an appointment at the doctor's based on a health status according to an embodiment of the present invention.

Referring to FIG. 5, the wearable device measures biological information about a user at step S502, compares the measured biological information with previously stored biological reference information at step S504, and determines whether the health status of the user is normal or not based on a result of the comparison at step S506.

For example, if a heart rate included in heart beat information is out of any one of the lowest threshold and the highest threshold included in heart beat reference information, the wearable device may determine the heart health status of the user to be abnormal.

If, as a result of the determination at step S506, it is determined that the health status is not normal, the wearable device determines whether the health status is an emergency situation at step S508. The wearable device may determine whether the health status of the user is an emergency situation or not because an emergency situation stage and an abnormal stage have been set based on the importance of biological information and the degree that biological reference information has been deviated.

If, as a result of the determination at step S508, it is determined that the health status is an emergency situation, the wearable device notifies predetermined emergency contact information of emergency situation information at step S510. The emergency contact information may include an emergency center, an emergency phone number, and an acquaintance. The emergency situation information may include personal ID information, location information, and biological information.

If, as a result of the determination at step S508, it is determined that the health status is not an emergency situation, but is an abnormal state, the wearable device sends the measurement information, including the biological information, to the hospital management apparatus at step S512.

Thereafter, when a clinic visit request message is received at step S514, the wearable device receives appointment information from the user and sends it to the hospital management apparatus at step S516. The appointment information may include a hospital name, a doctor, and an appointment time.

Thereafter, when medical treatment for the user is completed, the wearable device receives customized health management information based on the contents of the medical treatment from the health management apparatus at step S518.

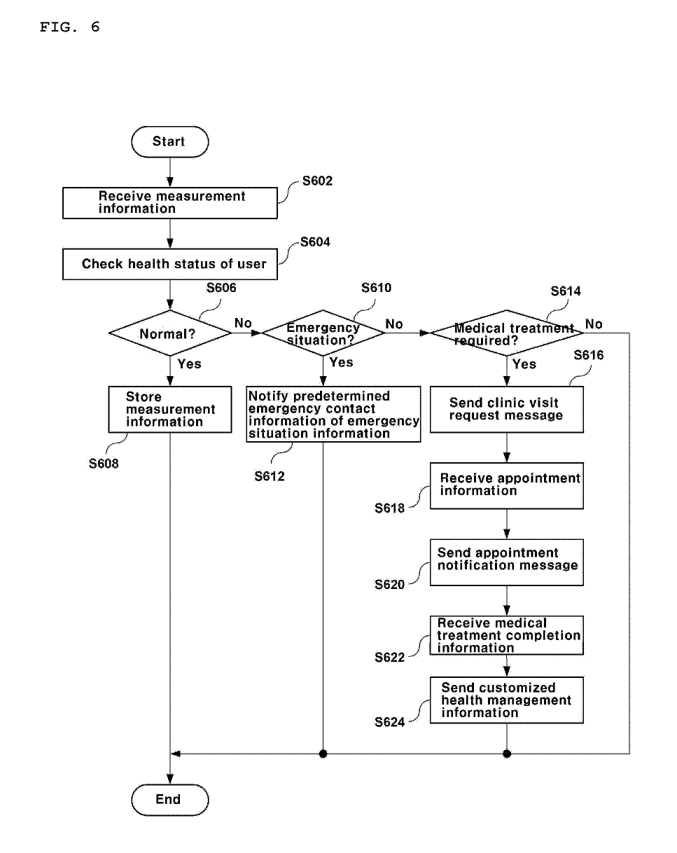

FIG. 6 is a diagram showing a method for performing, by the hospital management apparatus, an appointment at the doctor's based on a health status according to an embodiment of the present invention.

Referring to FIG. 6, when measurement information including biological information is received at step S602, the hospital management apparatus checks the health status of a user by checking the biological information at step S604, and determines whether the health status is normal or not based on a result of the check at step S606. In this case, the hospital management apparatus may compare the biological information with previously stored biological reference information, and may determine whether the health status of the user is normal or not based on a result of the comparison. Furthermore, the hospital management apparatus may receive health status check information, including information about an emergency situation and about whether medical treatment is required, from a medical staff.

If, as a result of the determination at step S606, it is determined that the health status is normal, the hospital management apparatus stores the measurement information at step S608.

If, as a result of the determination at step S606, it is determined that the health status is not normal and the health status is determined to be an emergency situation at step S610, the health management apparatus notifies predetermined emergency contact information of emergency situation information at step S612. The emergency contact information may include an emergency center, an emergency phone number, and an acquaintance. The emergency situation information may include personal ID information, location information, and biological information.

If, as a result of the determination at step S610, it is determined that the health status is not an emergency situation, but the user is determined to require medical treatment at step S614, the hospital management apparatus generates a clinic visit request message and sends it to the user at step S616. In this case, the hospital management apparatus may select a hospital in which medical treatment suitable for the health status of the user will be performed, may obtain a possible appointment time of the medical staffs of a corresponding medical treatment part in the selected hospital, may generate the clinic visit request message including the obtained hospital name, hospital route map, medical staff, and possible appointment time, and may send the generated clinic visit request message to the wearable device of the user. Furthermore, if a hospital or a doctor in charge (or the physician in charge) designated by the user is present, the hospital management apparatus may check a possible appointment time of the designated hospital and doctor in charge, may generate the clinic visit request message including a hospital name, a hospital route map, a medical staff, and a possible appointment time, and may send the generated clinic visit request message to the wearable device. Furthermore, if the hospital management apparatus manages a plurality of hospitals, the hospital management apparatus may select a hospital in which a doctor in charge or the physician in charge of the user works or a hospital having a use history based on the hospital use history of the user, may generate the clinic visit request message including the name of the selected hospital, a medical treatment object, a hospital route map, and a possible appointment time, and may send the generated clinic visit request message to the wearable device.

After the step S616 is performed, when appointment information is received from the user, the hospital management apparatus stores the appointment information at step S618 and sends an appointment notification message to the wearable device prior to an appointment date at step S620.

Thereafter, when medical treatment completion information is received at step S622, the hospital management apparatus generates customized health management information based on the contents of the medical treatment and sends it to the wearable device at step S624. That is, the hospital management apparatus generates customized health management information, including a coupon or loyalty points at a food store, a health food coupon, a sports equipment coupon, or hospital medical treatment points suitable for the user, based on the health status or disease of the user, and sends the generated customized health management information to the wearable device in a push form. For example, if blood pressure of the user is high, the hospital management apparatus may provide customized health management information, such as a discount coupon or loyalty points for health food which is good for blood pressure.

Such a method for providing a service for an appointment at the doctor's based on a health status may be written in a program form, and pieces of code and code segments forming the program may be easily inferred by a programmer skilled in the art. Furthermore, a program regarding the method for providing a service for an appointment at the doctor's based on a health status may be stored in readable media and may be read and executed by an electronic device.

As described above, those skilled in the art to which the present invention pertains will appreciate that the present invention may be implemented in other detailed forms without changing the technical spirit or essential characteristic of the present invention. Accordingly, it is to be understood that the aforementioned embodiments are only illustrative, but are not limiting or restrictive. Furthermore, the flowcharts shown in the drawings are merely sequential order illustrated to achieve the most preferred results in implementing the present invention, and other additional steps may be provided or some of the steps may be deleted.

Technological characteristics described in this specification and an implementation for executing the technological characteristics may be implemented using a digital electronic circuit, may be implemented using computer software, firmware or hardware including the structure described in this specification and structural equivalents thereof, or may be implemented using a combination of one or more of them. Furthermore, the implementation for executing the technological characteristics described in this specification may be implemented using a computer program product, that is, a module regarding computer program instructions encoded on a kind of program storage media in order to control the operation of a processing system or for execution by the processing system.

A computer-readable medium may be a machine-readable storage device, a machine-readable storage substrate, a memory device, a composition of materials that affect a machine-readable electromagnetic signal or a combination of one or more of them.

In this specification, the terms “apparatus” or “system” cover all apparatuses, devices, and machines for processing data, for example, including a processor, a computer or a multi-processor, or a computer. The processing system may include, for example, code that forms processor firmware, a protocol stack, a database management system, an operating system, or all types of code that form an execution environment for a computer program when a combination of one or more of them is requested, in addition to hardware.

A computer program also known as a program, software, a software application, a script or code may be written in any form of a programming language which includes a compiled or interpreted language or a transcendental and/or procedural language, and may also be implemented in any form including an independent program or module, a component, a subroutine or other units suitable for being used in a computer environment.

The computer program does not need to necessarily correspond to a file of a file system. The program may be stored in a single file provided to a requested program, multiple files that interact with each other (e.g., a file that stores one or more modules, a lower program or part of code), or another program or part of a file including data (e.g., one or more scripts stored in markup language document).

The computer program may be placed in a single site or distributed to a plurality of sites and may be implemented to be executed on multiple computers or one or more computers interconnected over wired/wireless communication networks.

A computer-readable medium suitable for storing computer program instructions and data may include semiconductor memory devices, such as EPROM, EEPROM, and a flash memory device, for example, all types of non-volatile memory, media, and memory devices including magnetic disks, such as an internal hard disk or an external disk, magneto optical disks, CDs, and DVDs. The processor and the memory may be supplemented by a logic circuit for a special object or may be integrated into the logic circuit for a special object.

An implementation for executing the subject matter described in this specification may be implemented in an operation system including a backend component, such as a data server, a middleware component, such as an application server, a frontend component, such as a client computer having a web browser or graphic user interface capable of interacting with the implementation of the subject matter described by a user in this specification or all combinations of one or more of the backend, middleware, and frontend components. The component of the system may be accessed by any type or medium for digital data communication, such as a communication network.

Hereinafter, a more detailed embodiment capable of implementing the elements included in the system and method for providing a service for an appointment at the doctor's based on a health status, described in this specification, along with the aforementioned contents is described in detail.

The system and method for providing a service for an appointment at the doctor's based on a health status, which have been described in this specification, may be used partially or generally through a server related to a client device or web-based storage system or means for executing computer software, program code or instructions on one or more processors included in a server. In this case, the processor may be part of a server, a client, network infrastructure, or a computing platform, such as a mobile computing platform or fixed computing platform. More specifically, the processor may be a kind of computer or processing device capable of executing program instructions, code, etc. Furthermore, the processor may further include memory for storing the method, instructions, code or program for providing a service for an appointment at the doctor's based on a health status. If memory is not included in the processor, the processor may access a storage device, such as CD-ROM, DVD, memory, a hard disk, a flash drive, RAM, ROM, or a cache in which the method, instructions, code or program for providing a service for an appointment at the doctor's based on a health status has been stored, through a separate interface.

Furthermore, the system and method for providing a service for an appointment at the doctor's based on a health status, which have been described in this specification, may be used partially or generally through an apparatus for executing computer software on a server, a client, a gateway, a hub, a router or network hardware. In this case, the software may be executed in various types of servers, such as a file server, a print server, a domain server, an Internet server, an intranet server, a host server, and a distributed server. The aforementioned servers may further include memory, a processor, a computer-readable storage medium, a storage medium, a communication device, a port, a client, and an interface capable of accessing other servers over wired/wireless networks.

Furthermore, the method, instructions, or code for providing a service for an appointment at the doctor's based on a health status may also be executed by a server. Other devices required to execute the method for providing a service for an appointment at the doctor's based on a health status may be implemented as part of a hierarchical structure associated with the server.

Furthermore, the server may provide an interface to other devices including a client, another server, a printer, a database server, a print server, a file server, communication a server, and a distributed server without limitation. A connection through the interface may enable a program to be easily executed at a remote place over wired/wireless networks.

Furthermore, any one of devices connected to the server through the interface may further include at least one storage device capable of storing the method, instructions or code for providing a service for an appointment at the doctor's based on a health status. The central processor of the server may provide instructions, code, etc. to be executed on another device to the device so that the instructions, code, etc. are stored in a storage device.

The system and method for providing a service for an appointment at the doctor's based on a health status, which have been described in this specification, may be used partially or generally through network infrastructure. In this case, the network infrastructure may include all of devices, such as a computing device, a server, a router, a hub, a firewall, a client, a personal computer, a communication device, and a routing device, and separate modules capable of executing respective functions. The network infrastructure may further include storage media, such as story flash memory, a buffer, a stack, RAM, and ROM, in addition to the aforementioned devices and module. Furthermore, the method, instructions or code for providing a service for an appointment at the doctor's based on a health status may also be executed by and stored in any one of the device, module, and storage medium included in the network infrastructure. Another device required to execute the method for providing a service for an appointment at the doctor's based on a health status may also be implemented as part of the network infrastructure.

Furthermore, the system and method for providing a service for an appointment at the doctor's based on a health status, which have been described in this specification, may be implemented using hardware or hardware suitable for a specific application and software. In this case, the hardware includes all of general-purpose computer devices, such as a personal computer and a mobile communication terminal, and a business type specific computer device. The computer device may be implemented using a device, such as memory, a microprocessor, a microcontroller, a digital signal processor, an application-specific integrated circuit, a programmable gate array, programmable array logic or a combination of them.

The aforementioned computer software, instructions, code, etc. may be stored or accessed by a readable device. In this case, the readable device may include memory, such as a computer component including digital data used for computing for a specific time, semiconductor storage, such as RAM or ROM, permanent storage, such as an optical disk, high-capacity storage, such as a hard disk, a tape and a drum, optical storage, such as a CD or DVD, and network access type storage, such as flash memory, a floppy disk, a magnetic tape, a paper tape, an independent type RAM disk, high-capacity storage detachable from a computer, dynamic memory, static memory, variable storage, and cloud. In this case, the instructions, code, etc. include all of languages, such as data-oriented languages, such as SQL and dBase, system languages, such as C, Objective C, C++, and Assembly, architecture languages, such as Java and NET, and application languages, such as PHP, Ruby, Perl, and Python, but are not limited thereto. The instructions, code, etc. may include all of languages widely known to those skilled in the art to which the present invention pertains.

Furthermore, the “computer-readable medium” described in this specification includes all of media which contribute to the provision of instruction to a processor in order to execute a program. More specifically, the “computer-readable medium” includes non-volatile media, such as a data storage device, an optical disk and a magnetic disk, volatile media, such as dynamic memory, and transmission media, such as a coaxial cable, a copper wire and an optical fiber for sending data, but is not limited thereto.

The elements for executing the technical characteristics of the present invention included in the block diagrams and flowcharts shown in the accompanying drawings of this specification mean the logical boundary between the elements.

In accordance with software or hardware embodiments, however, the functions of the illustrated elements and functions thereof may be implemented so that the elements and functions thereof are executed in the form of an independent software module, a monolithic software structure, code, a service or a combination of them and are stored in a medium which is executable by a computer including a processor capable of executing stored program code and instructions. Accordingly, all of such embodiments should be construed as belonging to the scope of the present invention.

Accordingly, the accompanying drawings and technologies thereof describe the technical characteristics of the present invention, but should not be simply reasoned unless a specific array of software for implementing such technical characteristics is clearly described otherwise. That is, the aforementioned various embodiments may be present and may be partially modified while having the same technical characteristics as those of the present invention. Accordingly, such modified embodiments should be construed as belonging to the scope of the present invention.

Furthermore, the flowchart describes operations in the drawing in a specific sequence, but has been illustrated to obtain the most preferred results. It should not be understood that such operations must be executed or all the illustrated operations must be executed in the illustrated specific sequence or sequential order. In a specific case, multi-tasking and parallel processing may be advantageous. Furthermore, the separation of various system components in the aforementioned embodiments should not be construed as requesting such separation in all the embodiments. It should be understood that the aforementioned program components and systems may be integrated into a single software product or packaged into a multi-software product.

In accordance with the embodiments of the present invention, the health status of an aged user can be checked and inconvenience attributable to a periodic medical checkup can be reduced because the health status of a user is checked using information measured by a wearable device and a user's appointment with a doctor is scheduled if medical treatment is required.

Furthermore, when a user finishes a clinic visit and medical examination at the appointed time, customized health management information for enhancing a user's health is provided to a wearable device or user device worn by the user. Accordingly, a user's health can be enhanced and the easy for a service use can be sought.

Furthermore, a user's emergency situation can be immediately handled by providing notification of an emergency situation in user health using biological information measured by the wearable device.

Advantages of the following embodiments are not limited to the aforementioned advantages, and various other advantages may be evidently understood by those skilled in the art to which the embodiments pertain from the following description.

As described above, the detailed terms proposed in this specification are not intended to limit the present invention. Accordingly, although the present invention has been described in detail with reference to the aforementioned embodiments, those skilled in the art to which the present invention pertains may reconstruct, change and modify the embodiments without departing from the scope of the present invention.

The scope of the present invention is defined by the appended claims rather than the detailed description, and the present invention should be construed as covering all modifications or variations derived from the meaning and scope of the appended claims and their equivalents.

What is claimed is:

1. An apparatus for providing a service for an appointment at a doctor's, the apparatus comprising:
a communication unit configured to perform communication with a hospital management apparatus;
a sensor unit configured to measure biological information about a user; and
a control unit configured to send the biological information measured by the sensor unit to the hospital management apparatus through the communication unit, receive appointment information when a clinic visit request message is received from the hospital management apparatus, and send the appointment information to the hospital management apparatus.

2. The apparatus of claim 1, wherein the control unit compares the measured biological information of the sensor unit with previously stored biological reference information, sends measurement information comprising the biological information to the hospital management apparatus through the communication unit if, as a result of the comparison, a health status is found to be abnormal, and notifies predetermined emergency contact information of an emergency situation if, as a result of the comparison, the health status is found to be a dangerous condition.

3. The apparatus of claim 1, wherein the control unit receives customized health management information based on contents of medical treatment from the hospital management apparatus.

4. The apparatus of claim 1, wherein:
the apparatus for providing a service for an appointment at the doctor's comprises a wearable device, and
the sensor unit measures the biological information of the user in real time.

5. A hospital management apparatus, comprising:
a communication unit configured to perform communication with a user device;
a health status check unit configured to determine whether a user requires medical treatment based on biological information when the biological information is received from the user device through the communication unit, generate a clinic visit request message if, as a result of the determination, it is determined that the user requires medical treatment, and send the clinic visit request message to the user device;
an appointment processing unit configured to store appointment information when the appointment information is received from the user device and to send an appointment notification message to the user device prior to an appointment date; and
a medical treatment completion processing unit configured to generate customized health management information based on contents of the medical treatment when medical treatment completion information is received and to send the customized health management information to the user device.

6. The hospital management apparatus of claim 5, wherein the health status check unit compares the biological information with previously stored biological reference information and determines whether the user requires the medical treatment based on a result of the comparison or sends the biological information to a medical staff and receives information about whether the user requires the medical treatment.

7. A method for providing, by a user device, a service for an appointment at the doctor's based on a health status, the method comprising steps of:
(a) measuring biological information about a user;
(b) determining a health status of the user by comparing the measured biological information with previously stored biological reference information; and
(c) sending the biological information to a hospital management apparatus if, as a result of the determination, it is determined that the health status of the user is abnormal, receiving appointment information when a clinic visit request message is received from the hospital management apparatus, and sending the appointment information to the hospital management apparatus.

8. The method of claim 7, further comprising a step of receiving customized health management information based on contents of medical treatment from the hospital management apparatus after the step (c).

9. The method of claim 7, wherein if the health status of the user is an emergency situation at the step (c), predetermined emergency contact information is notified of emergency situation information.
